(19) United States
(12) Patent Application Publication
(10) Pub. No.: US 2010/0215222 A1
(43) Pub. Date: Aug. 26, 2010

(54) Method And System For Removing Undesired Plant Parts

(75) Inventors: Ronald Zeelen, Delft (NL); Erwin John van Zwet, Delfgauw (NL)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Nederlandse Organisatie voor toegepast- natuurwetenschappelijk Onderzoek TNO, Delft (NL)

(21) Appl. No.: 12/530,113

(22) PCT Filed: Mar. 7, 2008
(86) PCT No.: PCT/NL2008/050135

§ 371 Date: Mar. 26, 2010

(30) Foreign Application Priority Data
Mar. 8, 2007 (EP) 07103790.7

(51) Int. Cl. G06K 9/00

(52) U.S. Cl. 382/110

(57) ABSTRACT

Method and system for removing undesired plant parts (9). A first cap (7) and means (13) are provided for lowering that cap over the supposed plant parts location, pushing downwards any leafs (8) etc. Around the supposed plant parts location. Means (15) are provided for making at least one image of the supposed plant parts location from several sides through the cap. Processing means (3) process the image(s) of the supposed plant parts location and localize any plant part to be removed. Means (16) are provided for excising any plant part through the first cap under control of said processing means (3). A second cap (14) may be provided extending outside and arranged co-movable with the first cap (7). The means for making at least one image of the supposed plant parts location and the means for excising any plant part to be removed reside inside the gap between the first cap and the second cap.

### FIELD OF THE INVENTION

The invention concerns a method for removing undesired plant parts like buds, runners etc., by means of a suitable system.

### BACKGROUND

“Plant fluffing”, i.e. removal of undesired buds, runners etc. from plants, e.g. chrysanthemum or rose, is a labor intensive and tiresome work: buds etc. are removed manually in a face down position.

### SUMMARY

It is an object to provide a method and a system for automatic “plant fluffing”, as a result of which the labor intensive and tiresome work can be taken over by a system.

It is preferred that the method comprises the steps as claimed in claim 1. A system according to claim 2 is provided.

A cap is placed over the plant (part) to push away any leafs etc. around a supposed plant parts location, typically both leafs etc. of the plant which is processed at that moment and those of the surrounding plants. After that the cap—and the plant parts—may remain unmovable until the “fluffing” process of that plant has been completed.

At least one image of the supposed plant parts location is obtained from several sides through the cap. An image sensor such as a camera, a sonar device or a radar may be used to obtain the image or images. A plurality of images from different sides may be obtained, or the imaging device may be moved relative to the cap while an image is taken.

The at least one image of the supposed plant parts location is processed to localize a plant part to be removed, and preferably any plant part to be removed. The plant part to be removed, and preferably any plant part to be removed, is or are excised through the first cap under control of the processor. Excision may be performed for example using an energy beam, such as a laser beam, a projected fluid beam or by mechanical removal.

### BRIEF DESCRIPTION OF THE DRAWING

These and other aspects will become apparent from a description of exemplary embodiments, using the following figures

FIG. 1 shows an exemplary embodiment of a system for removing plant parts;

FIG. 2 shows the same embodiment more in detail.

### DETAILED DESCRIPTION OF EXEMPLARY EMBODIMENTS

In an embodiment a (first) cap which is placed over the plant (part) pushes away any leafs etc. around a supposed plant parts location, typically both leafs etc. of the plant which is processed at that moment and those of the surrounding plants. After that the cap—and the plant parts—may remain unmovable until the “fluffing” process of that plant has been completed.

To obtain at least one image of the supposed plant parts location through the first cap as well as to excise any plant part to be removed to move around the outer surface of that cap without being hindered by surrounding plant parts like leaves etc., in an embodiment a second, outer cap, extending outside is provided, arranged co-movable with the first cap. Means for making at least one image of the supposed plant parts location and means for excising any plant part to be removed preferably reside inside the gap between the first, inner cap and the second, outer cap.

In an embodiment the first and/or second cap may be of a substantially cylindrical shape.

In an embodiment the location of supposed plant parts is determined by drive means which are arranged to position the system—i.e. the relevant system modules—to predetermined coordinates which correspond with or are at least derived from the position of the individual plants. Often the position of the individual plants are known beforehand, i.e. from a cultivation plan which comprises data w.r.t. the location of each individual plant, e.g. within a greenhouse.

At least one image of such a supposed plant parts location may be obtained from several sides (directions) through the cap using at least one image sensor which is arranged be moved along the outside of the cap under control of first position control means. As a preferred example the cap is a transparent cap and the means for making at least one image of the supposed plant parts location comprises at least one camera. As an alternative the cap might be not transparent but “permeable” for alternative detection means as e.g. radar type or sonar type or other image detectors.

Preferably, a processor is provided configured to process the at least one image of the supposed plant parts location and position data from said first position control means such that the exact position of any plant part is determined. The processor processes the image information from the image sensor(s), camera(s) or other kind of image detector(s) related to the position of the image detector, derived from the first position control means. When the processing means conclude the presence of an undesired bud or plant part at a certain position, this position is transmitted—e.g. via a data buffer—to second position control means.

In an embodiment an excising unit is provided that is arranged to excise plant part or plant parts under control of the processor and second position control means, the latter being responsible for the control of the excising unit.

In an embodiment the excising unit comprises a transmitter for transmitting a high energy beam causing those plant part or plant parts to be burned off. As an example a laser source could be used, which is able to transmit a high-energetic beam via the (transparent or at least translucent) first cap to the bud or plant part and to excise it by burning off.

In an embodiment the excising unit comprises means for transmitting a fluid projector for transmitting a fluid beam causing those plant part or plant parts to be cut off. In that case the first cap has to be made of a special permeable material, e.g. comprising a grid of holes through which the pressurized fluid can be squirted. Besides, the second position control means, responsible for the control and operation of the pressurized fluid, has to know and to take into account the exact location of each hole in order to be able to prevent that the fluid beam is hindered by the cap wall outside the holes provided in it.

The high pressurized fluid may comprise a growth inhibiting agent, in order to prevent re-sprouting of the excised butt.

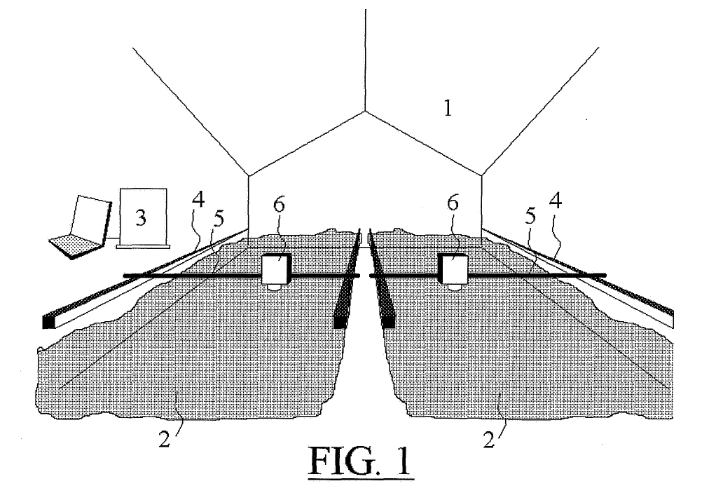

FIG. 1 shows a greenhouse 1 for growing plants 2. The individual plants 2 normally will be planted according to a predetermined, regular pattern, the data of which may be present in a computerized greenhouse management system 3. In an embodiment this data may be used as means for determining an expected location of plant parts, which will be termed the location of supposed plant parts. In this embodiment the determination of the location of supposed plant parts simply is performed by reading out or computing the x-y data of the individual plants from the data stored in computer 3. Alternatively, the location of supposed plants may be determined for example by means of image recognition, mechanical sensing, read-out of electronic tags attached to or near plants etc.

The greenhouse 1 comprises a transportation system, schematically indicated by a system of mutually perpendicular guiding bars 4 and 5 etc. which is capable to position a module 6 which is used for the execution of the further steps. It is noted that several assemblies 4,5,6 may be installed within a greenhouse 1 and that several modules 6 may simultaneously be in operation.

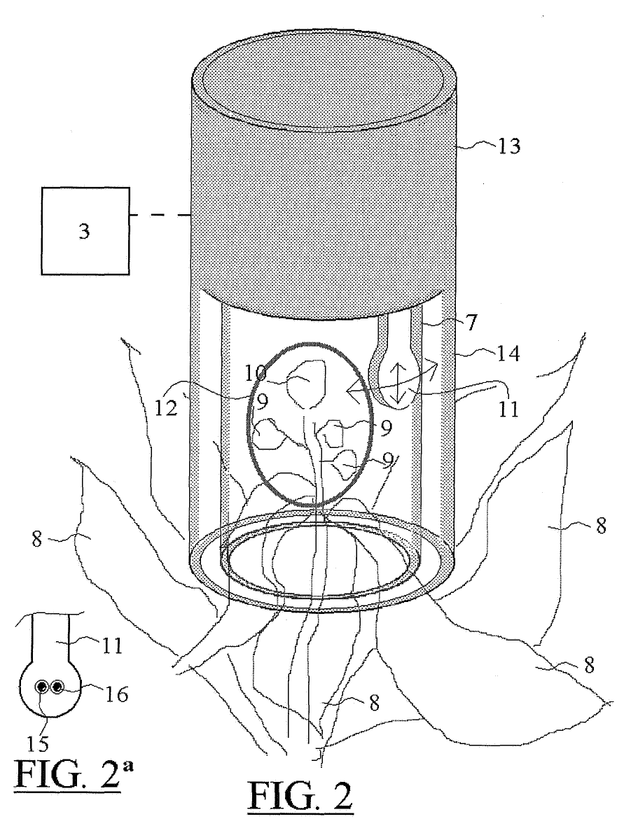

FIG. 2 shows schematically module 6 which is used for the execution of the further steps. Not shown is the construction by which module 6 is (e.g. slidably) connected the relevant bar 5; such a construction is deemed to be within the capabilities of persons skilled in the art.

Module 6 comprises a first cap 7 and a mechanism (not shown explicitly) for lowering that cap over the supposed plant parts location (derived from computer 3), pushing downwards any leafs 8 etc. around the location where possible undesired plant parts, like flower buds 9, are supposed to reside and thus making those undesired plant parts better visible. The mechanism for lowering the cap may contain a motor, or a pneumatically driven piston for example, mechanically coupled to the cap. It is noted that in this exemplary embodiment it is deemed that all side buds 9 have to be removed from the plant in favor of the grow of one flower bud 10.

The module 6 moreover comprises a module 11 which is arranged for making at least one image of the location 12 where the buds 9 and 10 reside, from several sides, through the cap 7. Module 11 constitutes an imaging device. It may contain one or more optical camera's, and/or one or more sonar sensors and/or one or more radar sensors or any other device capable of obtaining an image, i.e. a set of data as a function of position. A position controller for driving the module 11 may reside in the upper part 13 of module 6. The position controller may comprise a stepper motor with appropriate driver electronics etc. or any other driving mechanism. The position controller is configured to let the module 11 circle around the outside of cap 7. As a result images from different sides can be obtained, or a single image may be obtained while the module 11 circles cap 7. Alternatively, a plurality of images may be obtained by distinct image sensors at respective sides of the cap.

Images which are picked up by module 11 can be processed in a processor, e.g. under control of image processing software incorporated in computer 3 or any other programmable processing circuit, for localizing any bud 9 to be removed. Image processing algorithms for detecting buds 9, or other types of undesired plant parts such as runners, and determining their position from image data is known per se.

After having localized the buds 9 to be removed, those undesired buds are removed or excised. The buds 9 localized by the module 11 and the software in computer 3 are excised through the cap 7, under control of said processor. Excising means in the form of e.g. a laser beam generator may be used, comprising a laser diode for example. Alternatively a fluid projector may be used to project a beam of fluid or mechanical removers. In an embodiment the fluid beam may comprises a growth inhibiting agent that is thus applied selectively to the locations where undesired plant parts may develop. A laser beam of sufficient energy to remove buds 9 is used, or the pressure with which a fluid beam is projected is made sufficiently high to remove buds. The required level of energy or pressure may be determined experimentally.

The means for making images of the buds 9 and the means for excising the buds 9 may both be housed within the module 11, which is capable to be moved around, upwards and downwards (see arrows) under control of control hardware and software as represented in FIG. 1 by the computer system 3. So first the imaging module, e.g. a normal digital mini-camera, is moved first to localize the undesired buds, whilst next the excising means, e.g. a laser diode, is moved into the right positions and energized subsequently under control of the control hardware and software to excise the undesired buds 9.

FIG. 2a shows part of module 11 more in detail at the side which in use is directed towards the inside of cap 7. FIG. 2a shows that module 11 comprises a digital camera 15 and a laser 16, side by side. As both, camera 15 and laser 16, in fact are electro-optical convertors (camera 15 from optical-to-electrical and laser 16 electrical-to-optical) both could be combined by one single electro-optical conversion module which in one step is used as a camera, to make pictures of the plant parts 9 and 10, and in a subsequent step as a laser, to generate a laser beam to “shoot off” the undesired buds 9.

To enable the module 11 to move around the outer surface of cap 7 without being hindered by surrounding plant parts like leaves 8 etc., a second, outer cap 14, extending outside and arranged co-movable with the first cap 7. The means for making at least one image of the supposed plant parts location and the means for excising any plant part to be removed, housed in module 11 reside inside the gap between the first, inner cap 7 and the second, outer cap 14.

The cap 7 may be a transparent cap (i.e. a cap that is sufficiently transparent for the waves that are used to obtain the image in order to obtain the image of the plant parts inside the cap with sufficient spatial resolution to localize the undesired plant parts). The means for making at least one image of the supposed plant parts may comprise at least one camera. As an alternative the cap 7 might be not transparent but “permeable” for alternative detection means as e.g. radar type or sonar type or other image detectors.

Although an example has been given for buds, it should be appreciated that other types of plant part that are designate to be undesired, such as runners, may be treated in a similar way.

In summary a method may be used, comprising the steps of
determining the location of supposed plant parts;
lowering a cap over the supposed plant parts location, thus pushing away any leafs surrounding the supposed plant parts location;
make at least one image of the supposed plant parts location from several sides through the cap;
localize any plant part to be removed by processing said at least one image;
excise any plant part to be removed using means which are capable to excise those plant part or plant parts through the first cap under control of the processed at least one image.

1. A method of removing undesired plant parts, the method comprising the steps of:
lowering a cap over a plant parts location, thereby pushing away leaves surrounding the plant parts location with the cap;
making at least one image of the plant parts location from several sides through the cap;
processing the at least one image to localize a plant part to be removed; and
excising the plant part to be removed through the cap under control of information obtained from the processed at least one image rendered by the processing step.

2. System for removing undesired plant parts, the system comprising
a first cap;
a mechanism for lowering the first cap over a plant parts location, pushing downwards any leafs around the plant parts location;
an imaging device arranged for making at least one image of the plant parts location from several sides through the first cap;
a processor configured to process the at least one image of the plant parts location and to localize any plant part to be removed;
an excising unit for excising any plant part to be removed and arranged to excise those plant part or plant parts through the first cap under control of said processor.

3. The system according to claim 2, comprising a second cap, extending outside and arranged co-movable with the first cap, at least a part of the image capturing device for making at least one image of the plant parts location and/or at least a part of the excising unit for excising any plant part to be removed residing inside a gap between the first cap and the second cap.

4. The system according to claim 2, comprising a driver which is arranged to position the first cap to predetermined coordinates, which correspond with or are at least derived from a position of an individual plant, before lowering the cap.

5. The system according to claim 2, wherein the imaging device comprises at least one image sensor which is arranged to be moved along an outside of the first cap under control of a position controller.

6. The system according to claim 5, wherein the processor is configured to process the at least one image of the plant parts location and position data from the position controller such that an exact position of any plant part is determined.

7. System according to claim 5, wherein the excising unit is arranged to excise the plant part or plant parts under control of said processor and said position controller.

8. The system according to claim 4, the first cap being a transparent cap and the imaging device comprising at least one camera.

9. The system according to claim 6, the excising unit comprising a beam transmitter for transmitting a beam of sufficient energy to cause the plant part or plant parts to be burned off the plant.

10. The system according to claim 6, the excising unit comprising a fluid projector for projecting a fluid beam with sufficient pressure to cause the plant part or plant parts to be cut off the plant.

11. The system according to claim 9, the fluid in the fluid beam comprising a growth inhibiting agent.

12. A system for removing undesired plant parts, performing the method according to claim 1, the system comprising:
means for determining a location of plant parts;
a first cap and means for lowering the first cap over the plant parts location, the first cap pushing downwards any leave around the location of plant parts;
means for making at least one image of location of plant parts from several sides through the first cap;
processing means for processing the at least one image of the location of plant parts and for localizing any plant part to be removed;
means for excising any plant part to be removed, the means for excising being arranged to excise the plant part or plant parts through the first cap under control of said processing means.
